(19) United States
(12) Patent Application Publication
(10) Pub. No.: US 2016/0243734 A1
(43) Pub. Date: Aug. 25, 2016

(54) MICROFLUIDIC OR MICROTITER DEVICE AND METHOD OF MANUFACTURE OF MICROFLUIDIC OR MICROTITER DEVICE

(71) Applicant: Sony DADC Austria AG, Salzburg (AT)

(72) Inventors: Maximilian PITZEK, Salzburg (AT); Andrej PETERCA, Kuchl (AT); Nora DOPPELMAYER, Hallein (AT)

(73) Assignee: Sony DADC Austria AG, Salzburg (AT)

(21) Appl. No.: 14/631,021

(22) Filed: Feb. 25, 2015

(51) Int. Cl. B29C 45/00; B01L 3/00

(52) U.S. Cl. CPC B29C 45/0001; B01L 3/502707; B01L 3/5085; B01L 2200/12; B01L 2200/10; B01L 2200/028; B01L 2300/12; B29K 2023/00

(57) ABSTRACT

A method of manufacturing a microfluidic or microtiter device, the method comprises fabricating, by a single compression injection molding operation, a microfluidic or microtiter device having one or more indentations, in which a base thickness of the one or more indentations is less than 400 μm. In embodiments, the fabricating step comprises: forming a mold cavity; filling the mold cavity with molten material; closing the mold cavity; and driving one or more molding formations complementary to the one or more indentations into the mold cavity.

### FIELD OF THE DISCLOSURE

This disclosure relates to microfluidic or microtiter devices and methods of manufacture of microfluidic or microtiter devices.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Microfluidic or microtiter devices may be manufactured by a multi-stage molding process. An example of a microfluidic or microtiter device is a so-called microtiter plate. Such a plate, otherwise known as a microtitre plate, a microplate, a micro-well plate or a multi-well plate, typically comprises an array of small wells or indentations which form reaction or observation vessels (in other words, miniature test tubes) to allow chemical, biological and/or reaction properties of substances placed into the wells to be observed (note that there are other applications for microtiter plates that do not include the direct observation of the well contents while in the wells, so that the microtiter plate acts primarily as a convenient set of reaction vessels, with the resulting reagents or other materials being transferred to other detection devices after the reaction. These typically have rounded well bottoms. One example are microtiter plates used for polymerase chain reaction studies, which can have particularly thin walls in comparison to other microtiter plates, to facilitate thermal cycling). Technical issues relating to microtiter plates will be discussed now, but the present technology is applicable to a wider range of microfluidic or microtiter devices, for example devices including microfluidic channels and other formations.

Each of the wells in a microtiter plate can be (at least partially) filled or loaded with one or more materials and/or reagents so that a reaction or other event relating to the materials and/or reagents can be observed in each of the loaded wells. An advantage of such an arrangement is that multiple wells can be observed simultaneously; existing microtiter plates can have 96 or more wells in a single plate. The “ANSI SLAS” standard comprises 6, 24, 96, 384, 1536 sample well plates. With the outer form factor always being the same the sample volume of an individual well decreases with the number of sample wells. This is important for the choice of which type to use, a choice which is coupled with a selection of the capabilities of any automated instrumentation and the available sample volume.

Various observation and detection techniques may be applied to the contents of the wells, for example optical techniques, at least some of which require the passage of light through a base or bottom of the wells. Therefore, the optical properties of the base portion of each well are significant to the overall usefulness of a microtiter plate.

Previously proposed microtiter plates, at least those for applications which require thin and flat well bottoms, are generally fabricated as a molded frame with a separately bonded or over-molded bottom plate. Such arrangements can have the disadvantages of high production cost, possible leakage and difficulty in obtaining the high level of optical properties which are desirable for such a plate.

### SUMMARY

This disclosure provides a microfluidic or microtiter device fabricated by a single compression injection molding operation and having one or more indentations, in which a base thickness of the one or more indentations is less than 400 μm.

Further respective aspects and features are defined in the appended claims.

It is to be understood that both the foregoing general description and the following detailed description are exemplary, but not restrictive of, the present disclosure.

### BRIEF DESCRIPTION OF THE DRAWINGS

A more complete appreciation of the disclosure and many of the attendant advantages thereof will be readily obtained as the same becomes better understood by reference to the following detailed description of embodiments, when considered in connection with the accompanying drawings, wherein:

FIG. 1 is a schematic perspective cut-away view of part of a microfluidic or microtiter device

FIG. 2 is a schematic cross-sectional view of a part of a microfluidic or microtiter device;

FIGS. 3 to 8 schematically illustrate respective process steps in a method of manufacture of a microfluidic or microtiter device;

FIG. 9 is a schematic cross-sectional view of a part of a microfluidic or microtiter device; and

FIG. 10 is a schematic flow chart illustrating a method of manufacture of a microfluidic or microtiter device.

FIG. 11 is a schematic perspective view of a microtiter plate at the completion of a molding process;

FIG. 12 schematically illustrates a protective base plate;

FIG. 13 schematically illustrates an arrangement in which a microtiter plate is fitted to a base plate;

FIG. 14 schematically illustrates the arrangement of FIG. 13, in which a covering film has been applied to the upper surface;

FIG. 15 schematically illustrates an exploded view of a molding apparatus;

FIG. 16 is a more detailed view of a base plate attached to a microtiter plate; and

FIG. 17 schematically illustrates a part of a base plate.

### DESCRIPTION OF THE EMBODIMENTS

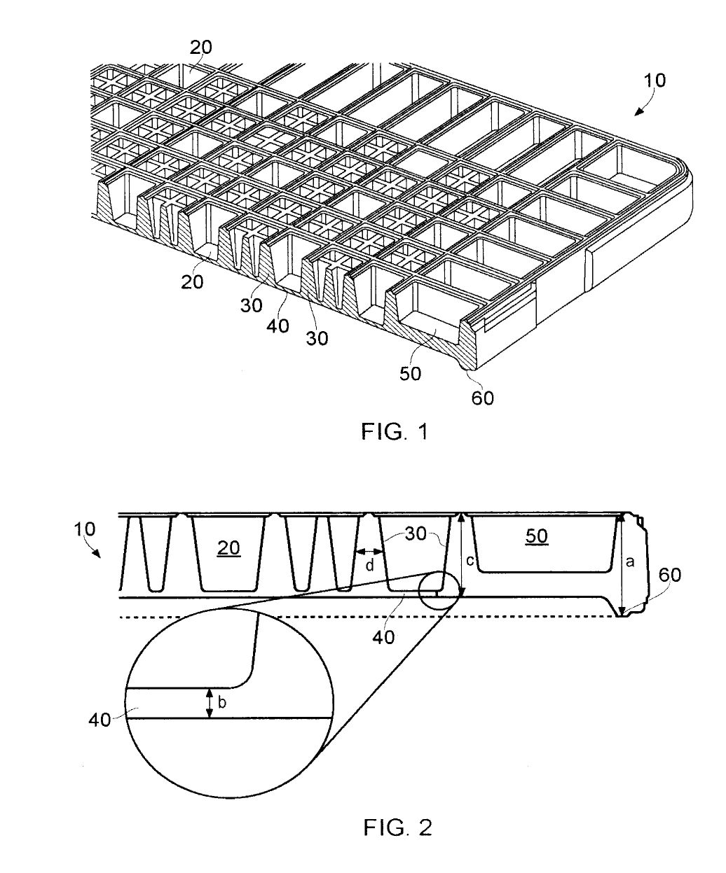

Referring now to the drawings, FIG. 1 is a schematic perspective cut-away view of part of a microfluidic or microtiter device 10. The particular example shown in FIG. 1 is that of a so-called microtiter plate having an array of indentations. As will be discussed below, FIG. 1 provides an example of a microfluidic or microtiter device fabricated by a single compression injection molding operation and having one or more indentations, in which a base thickness of the one or more indentations is less than 400 μm.

The example in FIG. 1 shows a partially cut-away view of what is in fact a rectangular microtiter plate having an array of wells 20. In this example, the plate measures 128 mm×85 mm×5.5 mm. Wells of differing sizes are provided, and indeed in various example embodiments the well volume can be any desired volume between about 20 μl and 0.3 ml by varying the cross-sectional area and/or the depth of the wells. Note however that a well need not be filled with material during its use; for example, a 43 μl well could be used to hold a sample of about 20 μl.

The example microtiter plate of FIG. 1 has a layout of 96 active wells, but with the well size being equivalent to that of a conventional 384 well plate. This allows analysis of small volumes of analyte (such as 20 μl of analyte) but in a convenient 96-well layout. Wells in between the active wells have a volume of about 5 μl. These are intended to be dummy wells, but could instead be fabricated (or just used in their present form) as active wells. Each well 20 is defined by upstanding walls 30 and a base 40. The walls 30 are slightly tapered, which is to say that the well is generally smaller in terms of its cross-section at the base or bottom of the well, and slightly larger at the open end of the well as drawn. The reasons for this slight taper will be discussed below with reference to a description of a method of manufacturing such a plate. But note that the taper is optional.

In use, one or more materials or reagents to be studied are inserted into one or more of the wells and are exposed to an appropriate temperature, reaction time and/or other conditions appropriate to the tests being carried out. At the appropriate stage, the contents of the wells are examined. A valuable aspect of the use of microtiter plates of the type being described is that multiple tests can be carried out simultaneously. This is made possible by the fact that a typical microtiter plate might have many tens of wells, for example 96 wells, all of which are fluidically isolated from one another so that separate tests can be carried out in each respective well. Arrangements such as needle droppers are used to dispense materials and/or reagents into the wells, either one well at a time or (perhaps more typically) in groups of several wells at a time or even a whole plate at a time. Similarly, the tests carried out on the contents of the wells (which will be described further below) may be carried out on groups of multiple wells in parallel, or in some instances on all of the wells of a single plate in parallel.

Various techniques may be used to test the contents of the array of wells, for example using a device such as a so-called microplate reader. A microplate reader is an instrument for detecting biological, chemical or physical aspects of the contents of the wells in a microtiter plate. An example of a detection technique is an optical detection technique in which the contents of a well are examined using some form of optical test. Example tests include: detecting the optical absorption at one or more sample wavelengths of the well contents; detecting the fluorescence of the well contents in response to particular optical excitation; detecting the luminescence, which is to say light emitted as a result of a reaction taking place in a well; detecting the time-dependence and/or polarisation of any of the above; and/or detecting the way in which light is scattered from the contents of a well. A particular example technique is the use of so-called confocal microscopy. This is an optical imaging technique used in some instances of microtiter plate assays, and which (in common with at least some of the other optical techniques discussed above) relies upon the transmission of light through the base 40 of each well. In the confocal setup the resolution is the highest (i.e. axial resolution) therefore also yielding the highest fluorescence signals. It gives the highest signal to background ratios and especially applications where single molecules are detected rely on confocal measurement.

The quality of the results obtained through this or other optical techniques can depend upon the optical quality of the base 40, which may include factors such as its optical transmission (so that a higher quality result may be obtained if less light is absorbed by the base 40) and its optical distortion (so that a higher quality result may be obtained if the light which passes through the base 40 is subject to lower distortion). Embodiments of the present disclosure aim to produce a microtiter plate or other microfluidic or microtiter device having a base 40 in at least active ones of the wells 20 which is substantially transparent and which imposes low optical distortion. In the examples to be discussed below, a technique is described for producing a thin and accurately shaped base 40 in the active wells, having (in embodiments of the disclosure) a low auto-fluorescence signal during detection.

Note that a thin base 40 is particularly significant in systems where a plate reading technique uses confocal microscopy. Here, a very thin base 40 is needed to allow so-called high numerical aperture detection (with a numerical aperture of, say, 0.8 and a readout distance between the optical components and the sample of perhaps 0.7 mm). Techniques such as confocal fluorescence excitation and readout relies on a very small interaction volume, and again is helped by the ability to produce small wells and to have a thin base 40. A base tilt of less than +/−10 μm (achievable using this technology) to avoid prism effects and a waviness (flatness) of less than +/−10 μm, to avoid optical distortions and lens effects are considered useful for confocal applications.

To complete a description of FIG. 1, so-called “dummy” wells 50 are provided around the periphery of the microtiter plate 10 (and, in some examples, between active wells). The dummy wells may have the same or a thicker base than the base 40 used in the active wells 20 (where an active well is one which is provided for use in an experiment of the type discussed above and which will be subject to an optical detection process, also as discussed above). The dummy wells provide a frame around the array of active wells 20 so as to provide additional strength and rigidity to the microtiter plate 10. There are various advantages associated with the use of dummy wells 50 rather than a solid boundary region around the plate 10. One advantage is that the use of dummy wells 50 provides additional strength to the plate as a whole, but without an unnecessary waste of material, which may be significant given that the material from which the plate 10 is produced may be a high-quality optical polymer or the like, such as a polymer which is transparent when set. Another advantage can apply to systems in which automated needle droppers are used to dispense reagents or other materials into the wells 20. If there is any alignment problem in the alignment of the plate 10 with the needle dropper machine, this could lead to the needle dropper attempting to dispense material into the dummy wells. If the dummy wells were in fact formed as a solid boundary, a needle dropper could strike that boundary and cause damage to the needle dropper machine. In contrast, the use of dummy wells means that the worst-case outcome in a situation in which the plate 10 is sufficiently badly aligned with the needle dropper machine so that the needle dropper hits a dummy well is that a small amount of reagent or other material will be wasted by being dispensed into the dummy wells 50. Of course, if the needle dropper is aligned with the inter-well walls or boundaries then damage could still occur. So, the use of the dummy wells can reduce but generally not eliminate needle damage by misalignment with the wells. A microtiter plate or other microfluidic device having active and dummy wells provides an example of a microfluidic or microtiter device in which the array of indentations comprises two or more respective subsets of indentations, each subset of indentations having a respective indentation volume so that the indentation volumes are different for each subset of indentations.

A further feature shown in FIG. 1 is a ridge 60 around the periphery of the underside of the plate 10. The formation of the ridge 60 will be discussed below. In use, it serves to raise the underside of the base 40 of the active wells 20 away from a surface onto which the plate is placed. Given that the optical properties of the base 40 of each active well are important for the reasons discussed above, the use of the ridge 60 can avoid damage, for example by scratching or contamination, occurring to the underside of the base 40 of the active wells 20.

Although not shown in FIG. 1, a typical additional feature of a microtiter plate is the use of a covering film over the top (open end) of the wells 20. In fact, the covering film may be provided over substantially the entire upper surface of the plate 10, that is to say, including at least a part of the dummy wells, for simplicity of fitting the covering film. An example of a suitable covering film is an aluminium film. The film can provide protection against contamination of the individual wells before use, and indeed can remain in place throughout the use of the microtiter plate; in such an instance, a needle dropper arrangement can provide a convenient way of puncturing the film at the appropriate position with respect to each well to allow reagents or other materials to be inserted into the wells. Note that in order to achieve a reliable seal when the covering film is applied to a plate 10, there is a need for the upper surface collectively provided by the top of the walls 30 of the wells 20 to be flat.

For shipping the plate, a bottom protection plate of, for example, polystyrene loaded with black carbon, can be used to avoid damage to the plate as a whole and in particular to the underside of the base 40 of each active well, for example during shipping or handling by a biomedical laboratory. The bottom protection plate can be removably locked or latched to the microtiter plate. Such a plate would be removed before any attempt at optical measurements with respect to the contents of the wells, but could in principle be left in place in situations where non-optical processes or measurements are being undertaken.

Previously proposed microtiter plates with thin and flat bottoms generally used a bonded or over-molded bottom sheet attached to a molded frame. The bottom sheet would provide the base 40 of each active well, and the frame would provide the walls 30 of the active wells. However, such arrangements had the disadvantage of high production cost a risk of leakage and a difficulty in achieving a required level of optical quality. Also important is the cleanliness of the product. The other process approaches include several process steps, which multiplies the risk of contamination with dust, enzymes, DNA, RNA or other unwanted environmental contaminants. Especially DNA, RNA, or ribonuclease-free requirements for production of disposables is very hard to verify and guarantee without using very hard sterilization techniques. In the best case these sterilization methods would add substantially to the cost of the device, but typically they have a strong effect on the plastics itself as well, deteriorating especially the optical properties of the device. Lowering the probability of contamination by high automation and fast processing is an appropriate way of providing or aiming to provide high quality products.

In contrast, in the present disclosure, a monolithically molded microtiter plate is provided using, in at least some examples, an injection compression mold arrangement which allows the entire microtiter plate to be produced in only one process step. The manufacturer method to be discussed below is compatible with standard format microtiter plates such as the commonly used 96, 384 or 1536 well format, but also allows the well volume to be varied from well to well by varying dimensions of the wells such as their cross-sectional area, for example varying the cross-sectional area (as measured at the base 40) between, say, 0.2 mm² and 28 mm².

Embodiments of the disclosure allow the base 40 of the active wells to have one or more of the following properties:

(i) a thickness of below 400 μm and in some instances less than 300 μm or less than 250 μm;

(ii) a thickness distribution (that is to say, a variation of thickness between the thickest base 40 and the thinnest base 40 within a single plate 10) of less than 10% and in some instances less than 5% (of the thickness of the thickest base 40);

(iii) a flatness of less than 2 μm/millimetre and in some instances less than one micrometre/millimetre;

(iv) a low background fluorescence; and

(v) a low number of defects (such that the defective wells occupy less than 2%, and in some instances less than 1% of the active surface area of the plate 10).

FIG. 2 is a schematic cross-sectional view of a part of a microfluidic or microtiter device schematically illustrating three thickness parameters of the plate 10, labelled as a, b and c the parameter a relates to the overall thickness of the plate including the ridge 60. The parameter b relates to the thickness of the base 40. The parameter c relates to the height of each well from the upper surface of the plate 10 to the underside of the base 40. In an example embodiment, a=5.5 mm, b=0.25 mm and c=4.5 mm. This gives a ratio a/b of at least 22, and a ratio c/b of at least 18. Higher ratios still are considered possible using this technology. However, a ratio can also be expressed as the ratio of (c−b), or in other words the internal height of the well, to b, the base thickness. In this example this is 4.25 mm/0.25 mm, or 17, but in general terms such a ratio of at least 10 is provided in examples of the disclosure. In other examples, a ratio (c−b)/b of at least 17 is provided.

A thickness of a wall or boundary between adjacent wells can be, for example, less than 2 mm.

The value b can be, for example: less than 1 mm, less than 400 μm, less than 300 μm, or less than 250 μm.

In other examples, for similar values of b, the well width or diameter could be, for example, between 6.39 and 6.96 mm (varying with the taper mentioned above such that the wells are narrower at the base than at the open end). The internal well height could be, for example, 10.9 mm.

Note that in typical previously proposed single shot injection molded devices, b is typically 1 mm or more, and a is typically 14 mm, giving a/b of 14 or less. A typical limit on previously proposed fabrication techniques is how low the dimension b can be made. The lower limit using previously proposed technology is considered to be about 0.4-0.5 mm.

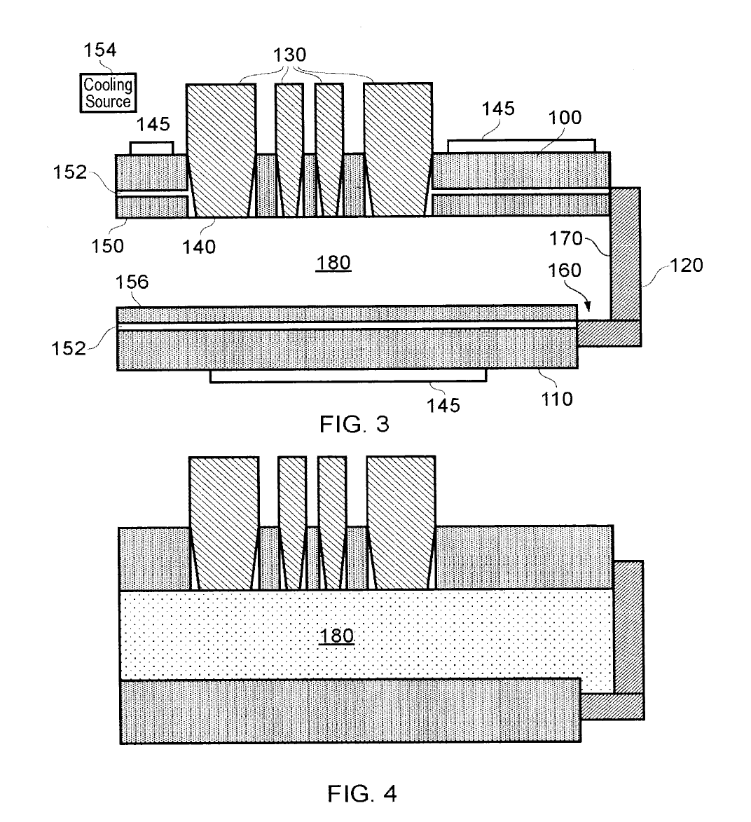

FIGS. 3 to 8 schematically illustrate respective process steps in a method of manufacture of a microfluidic or microtiter device. In particular, FIGS. 3 to 8 schematically illustrate stages in an injection compression molding process.

Starting with FIG. 3, a mold is formed of an upper mold plate 100 (also known as a movable mold plate), a lower mold plate 110 (also known as a stationary mold plate) and side walls 120. It will be appreciated that although the device (such as a microtiter plate) produced by the molding process may have a natural upwards direction in use, the references to “upper”, “lower” and “side” with reference to the molding process relate merely to the orientation of the drawing and not to any requirement for a particular orientation during operation of the process itself. Indeed, in an example machine, the two plates are vertically oriented and so act side by side. The terms are used simply to provide a clear description with reference to the drawings. Overall, the various parts of the mold, upper plates, lower plates and side walls, cooperate to provide a molding cavity complimentary to the desired configuration of the molded product, in this example a microtiter plate. For clarity of the diagram, however, only a part of the upper and lower plates, and only one side wall 120 have been shown in FIG. 3 (and indeed in the following diagrams FIGS. 4-7).

The upper mold plate 100 (referred to as a plate, but in fact could be referred to as a frame or comb, with many perforations corresponding to respective ones of the mold pins) includes multiple mold pins 130. In FIG. 3, these are shown in a retracted configuration so that a lower surface (as drawn) 140 of each mold pin is flush or substantially flush with a lower surface (as drawn) 150 of the upper mold plate 100. A deployed configuration will be discussed below in which the pins are moved downwards (relative to the orientation of the drawing) so as to protrude into the cavity formed by the upper mold plate 100, the lower mold plate 110 and the side walls 120. The mold pins are slightly tapered, which is to say that they have a slightly smaller cross-sectional area at their distal (lower, as drawn) end than at less distal regions of the mold pins. The intention is to create a tapered well profile, such that the cross-section of each well narrows from a narrowest cross section at the deepest part of the well (next to the base 40) to a larger cross-section at the open end of the well. This tapering (which can be slight, for example at an angle relative to the axis of the well of 0-7°) is provided in order to ease the removal of the mold pins from their respective indentations when forming the wells. Accordingly, for at least a portion of their length which forms a corresponding indentation, the mold pins are tapered so as to be narrower at a distal end.

In comparison with other molding technology, the pins 130 are rather longer than would otherwise be expected. Longer pins are used in the present examples (than in previously proposed arrangements) to allow for a thicker upper mold plate 100, for example having a thickness of 50 mm (the thickness being represented in a vertical direction in the representation of FIG. 3). The pins are (for example) about or at least 70 mm long. The reason that a thick mold plate 100 (and in some examples a thick mold plate 110) are used is that the high molding pressure of greater than 60 MPa within the cavity 180 could otherwise lead to bowing or bending of the upper mold plate 100. The reason that the upper mold plate 100 is more susceptible to bending under the molding pressure is that in order to allow access to and motion of the mold pins 130, the upper mold plate 100 is supported only at its edges.

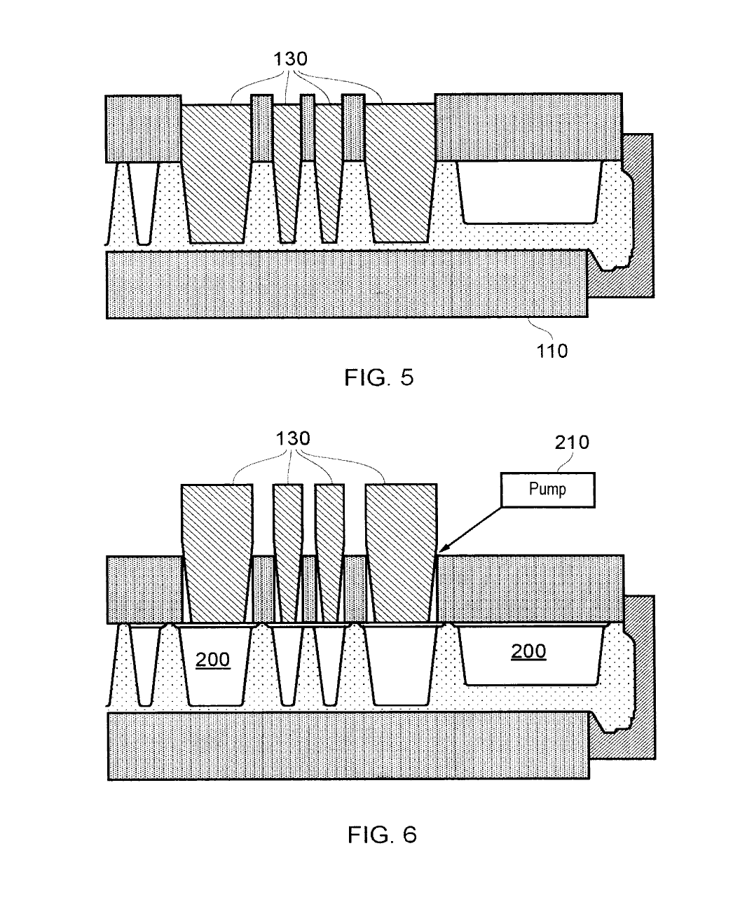

The side walls 120 form an outside frame so as to define a cavity 160 corresponding to the ridge 60 at the underside of the microtiter plate 10 of FIG. 1. Generally speaking, an inner profile 170 of the side walls 120 is comp entry to an outer side profile of the finished device. In FIGS. 3 and 4, this profile 170 is shown as a simple rectangular profile. In FIGS. 5-8, this profile is shown with a more finely machined appearance. Functionally, the inner profile 170 of the side wall 120 serves to provide an attractive and easily manipulated outer edge of the finished device 10 and two provide a downwardly (as drawn) depending ridge 60. Note also that the edges in the outside frame help during the multiple steps of demolding and ejecting the molded part from the frame.

A polymer material which is transparent when set (such as amorphous polymers or some semi-crystalline polymers) is used in the molding process. Examples of such a material include:
Cyclo Olephine Polymer (COP) grades with glass transition temperature (Tg) between 100 and 160° C., for example Zeonor 1060R
Cyclo Olephine Copolymer (COC) grades with glass transition temperature (Tg) between 100 and 160° C.
Polypropylene
Polystyrene
Polycarbonate
Polymethyl methacrylate
PVC (Polyvinyl chloride)
PPE (Polyphenyl ether)
SAN (Styrene-acrylonitrile)
PET (Polyethylene terephthalate)
PE (Polyethylene)
Copolymers and blends of any permutation of the above-mentioned polymers

These example materials include materials which are appropriately transparent when set and which provide appropriate optical properties as discussed above. The polymer material is heated to a molten state, for example by heating to a temperature of approximately 160° C. (though in some examples at the time of injection the material has a temperature of 260° C., but this depends also on the type of material. It can be close to 300° in other examples) and is introduced into the cavity 180 formed by the mold plates and side walls. For example, the molten polymer may be introduced along a long edge of a substantially rectangular microtiter plate molding cavity, for example by temporary removal of a side wall along that long edge or by use of closable apertures within that side wall. By using the longer edge for introducing the molten material (as a so-called injection gate) a more uniform rapid filing of the cavity may be obtained.

The mold plates and other parts of the mold as shown in FIG. 3 are maintained at a temperature lower than the initial temperature of the molten polymer. For example, the mold parts can be maintained at a temperature of approximately 80° C., for example by a liquid-based or Peltier cooling arrangement arranged to cool the mold cavity. In the present examples, cooling is provided by cooling channels 152 which are shown schematically in FIG. 3 but (for clarity of the diagram) are omitted from FIGS. 4-7, and which are supplied with a cooling fluid (such as water at 20° C.) by a cooling fluid source 154. With regards to the lower mold plate 110, the cooling channels 152 can be arranged just a small distance such as 15 mm underneath the upper surface 156 of the lower mold plate 110. With regard to the upper mold plate 100, the situation is more complicated because of the array of pins 130, and indeed in some examples it may not be possible to include cooling channels 152 within the body of the upper mold plate, instead providing them on an upper (outer) surface of the upper mold plate or around the periphery of the upper mold plate. Other measures however can be provided to enhance cooling at the upper mold plate, such as the provision of copper cores within each of the mold pins 130 so as to provide better heat transfer along the length of the mold pins 130.

In some embodiments the mold plates are maintained at the same temperature as one another, which can help with the production of a molded part such as a microtiter plate which is flat overall. This can, however, still require that the two liquid cycles are maintained at different temperatures, since the heat transfer due to different channel layouts, channel distance from the surface etc. can be better on one mold side than the other. In other embodiments, the two mold plates may be controlled to have different temperatures so that the cooling comprises cooling different parts of the mold cavity to different temperatures. This can be done in some examples to compensate for other factors which would (if uncompensated) lead to the generation of a non-flat (bowed) plate, or in other words still with the aim of producing a flat molded product. However, in some examples, a temperature differential between the two mold plates can be used in order to promote the production of a non-flat (bowed) plate. The bow of the molded product (towards the hotter of the two plates, so the molded product is concave on the hotter side) provides a pre-compensation to a bow which would otherwise be imposed when a further subsequent process (such as when the covering film is laminated to or otherwise covered on the molded product) is carried out in a later stage, so that the pre-compensation bow substantially cancels out and is substantially complementary to the opposite bow introduced by the film bonding process, leading to an eventually substantially flat product including its covering film. Of course, it will be appreciated that overall flatness of the finally shipped product is desirable because the product will be used with other apparatus such as needle droppers and plate readers. Accordingly, in embodiments, the technique can comprise comprising selecting the different temperatures so that the molded microfluidic or microtiter device is bowed when released from the mold cavity, the method comprising applying a further process to the molded microfluidic or microtiter device so as to introduce a substantially complementary bowing, thereby producing a substantially flat microfluidic or microtiter device. The step of applying a further process can comprise covering at least some of the indentations with a covering film.

A hydraulic press (shown in a very schematic form as 145 in FIG. 3) provides pressure so as to urge the upper and lower mold plates together. That is to say, as drawn, pressure is applied so as to urge the upper mold plate 100 downwards and/or the lower mold plate 110 upwards (though in practice there might be just one movable mold plate). This tends to cause the molten polymer material to fill the cavity formed by the mold plates and side walls.

FIG. 4 schematically illustrates the arrangement of FIG. 3, with the cavity 180 filled with molten polymer material (indicated schematically by shading within the region corresponding to the cavity 180).

It is useful that the mold cavity be entirely filled very fast, for example over a period of just (approximately) 0.6 seconds, in order to be able to form the thin base regions 40. In other words, given that the mold plates are cooled, it is useful that the injected molten material is able to flow into all regions of the mold including those immediately adjacent to the mold plates (noting that the region immediately adjacent to the lower mold plate will ultimately form the base 40 of each well) before it sets too much.

A next stage, illustrated schematically in FIG. 5, is that the mold pins 130 are driven (for example, by a hydraulic press, not shown) towards the lower mold plate 110 so as to protrude into the cavity 180 (which, as discussed, is already filled with molten polymer material). In the example of FIG. 5, only four mold pins are shown, and indeed some indentations corresponding to mold pins are illustrated without the mold pins being drawn. This is simply for the purposes of clarity of the diagram and description. In a working embodiment, each mold pin would correspond to a respective indentation.

How far to drive the mold pins depends on the required base 40 thickness. For example, a step of driving the mold pins into the cavity can comprise driving the molding formations from one side of the cavity towards an opposite side of the cavity so that a distal end of each molding formation reaches a position within 400 μm (or indeed 300 μm, 250 μm or another required base thickness) of a surface of the opposite side of the cavity. Note that the mold pins can be driven independently of the frame (the upper mold plate) and of the outer cavity frame in which they are retained.

FIG. 6 schematically illustrates a stage in which the mold pins 130 are then withdrawn back to their retracted positions. This leaves respective cavities 200, one for each mold pin, in the molded material. Each of these cavities corresponds to either an active well 20 (in the case of cavities drawn to the left side of FIG. 6, having a thin base portion) or a dummy well 50 (in the case of the cavity drawn to the far right side of FIG. 6, having a thicker base portion).

In order to assist with the removal of the pins from the corresponding cavities 200, pressurised air (as an example of a cooling gas) may be directed, by a pump 210, around the periphery of each of (or at least some of) the pins 130 in a direction so as to blow air into the cavities 200. This has two main effects. One is that it helps to force the mold pins 130 out of their respective cavities. Another is that it helps to cool the molten material at the inner surface of each cavity 200, which can in turn provide a smoother and potentially optically more suitable inner well surface.

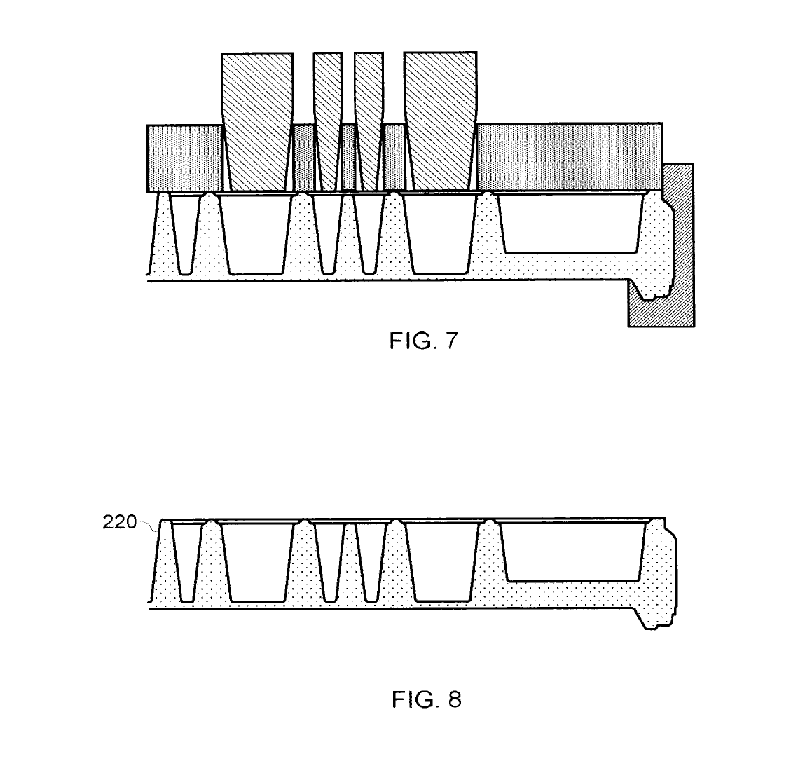

FIG. 7 schematically illustrates the next stage in which the lower mold plate 110 has been removed. FIG. 8 schematically illustrates a further stage in which the finished article 220 has been removed from the upper mold plate and the side walls.

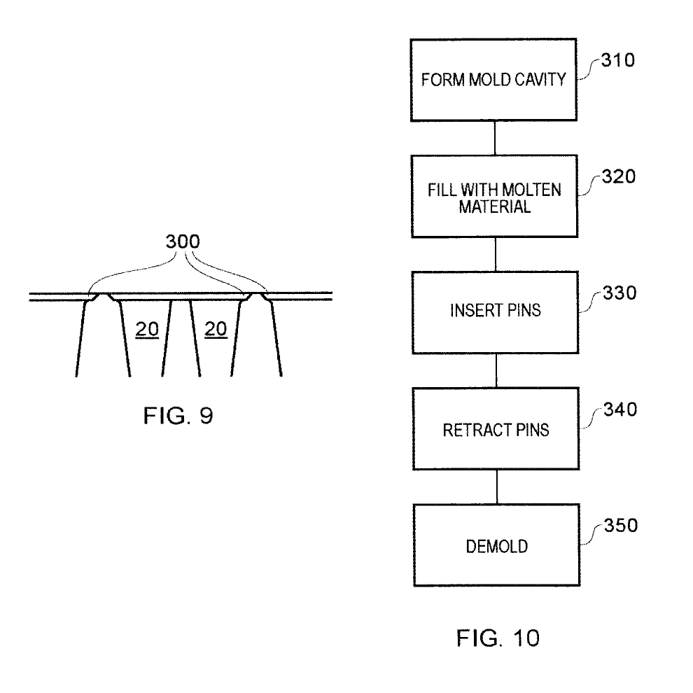

In other embodiments these two steps are switched. First the mold is opened so the handling arrangement can approach the part. Then the part is released while the handling arrangement grabs the part. This can avoid the part falling off the mold (particularly where the molded the part is substantially vertical in the mold) FIG. 9 is a schematic cross-sectional view of a part of a microfluidic or microtiter device, in particular illustrating a widened shoulder portion 300 at the upper edge of the wells 20. The shoulder portion 300 represents an indentation which extends beyond the lateral extent of the upper surface of the wells and is formed by corresponding protrusions in the lower surface (as drawn) of the upper mold plate 100. A reason for the shoulder portion 300 is that as the mold pins 130 are withdrawn from the corresponding indentations, an upwardly (as drawn) projecting burr can be produced. Also because of the minimum gap between the pins and the upper mold plate burrs can turn up. By actually ending the indentation slightly short of the upper surface of the finished article, any such burr is less likely to protrude above the upper surface of the finished article. Given that (as noted above) in at least some examples the finished article is sealed with a thin film covering, the use of the shoulder portion 300 can reduce potential damage to that thin film covering from the burrs.

FIG. 10 is a schematic flow chart illustrating a method of manufacture of a microfluidic or microtiter device and provides a summary of the process discussed above with reference to FIGS. 3-8. Note that these steps, taken together, form an example of a single compression injection molding operation and form an example of a method of manufacturing a microfluidic or microtiter device, the method comprising fabricating, by a single compression injection molding operation, a microfluidic or microtiter device having one or more indentations, in which a base thickness of the one or more indentations is less than 400 μm.

In summary the method comprises: forming a mold cavity; filling the mold cavity with molten material; closing the mold cavity; and driving one or more molding formations complementary to the one or more indentations into the mold cavity.

At a step 310, a mold cavity 180 is formed, for example by assembling an upper mold plate, a lower mold plate and side walls as discussed with reference to FIG. 3.

At a step 320, the mold cavity is filled with molten material as illustrated schematically in FIG. 4 above. The mold cavity is then closed. Note that the term “fill” can mean filling to 100% of its capacity, but in other examples the “filling” could be to a level near but not quite 100% of capacity, given that when the mold pins are inserted into the cavity 180, they will tend to force any remaining gaps to be filled with molten material. In other examples, the filling can be to substantially 100% of an initial capacity of the cavity 180.

At a step 330, the mold pins 130 are moved so as to protrude into the cavity 180 and therefore form indentations corresponding to each mold pin. This provides an example of driving one or more molding formations complementary to the one or more indentations into the mold cavity, for example by driving the molding formations into the mold cavity using a hydraulic press. As discussed above, in examples, the one of more molding formations can be mold pins, one pin for each indentation.

At a step 340, the mold pins are retracted to their retracted position.

At a step 350, the finished article is removed or “demolded”, for example by being gripped and pulled off the upper mold plate by a mechanical manipulator such as a robotic arm having a gripping tool at one end. As discussed above, the finished article may be coated with a thin covering film for protection against contamination.

A significant feature is the two-fold compression process described above, in which the mold pins are movable (for example, hydraulically) and the pin frame (upper mold plate) is movable as well. So the thick and thin regions of the product can be compressed by different pressures and shrinkage can be compensated by this movement. Therefore so-called sink marks (which might otherwise appear on the molded part) can be avoided or at least alleviated. This provides an example of an arrangement in which a mold cavity is formed by driving a plurality of mold parts together, and molding formations such as the pins are separately driven into the mold cavity that has been formed.

The same as above could in principle also be achieved by using only one compression, and a “holding pressure” or in other words an additional pressure from the material injection nozzle. In this case the material pressure would act as the second pressure unit that holds the frame regions. However, the double compression process is preferred.

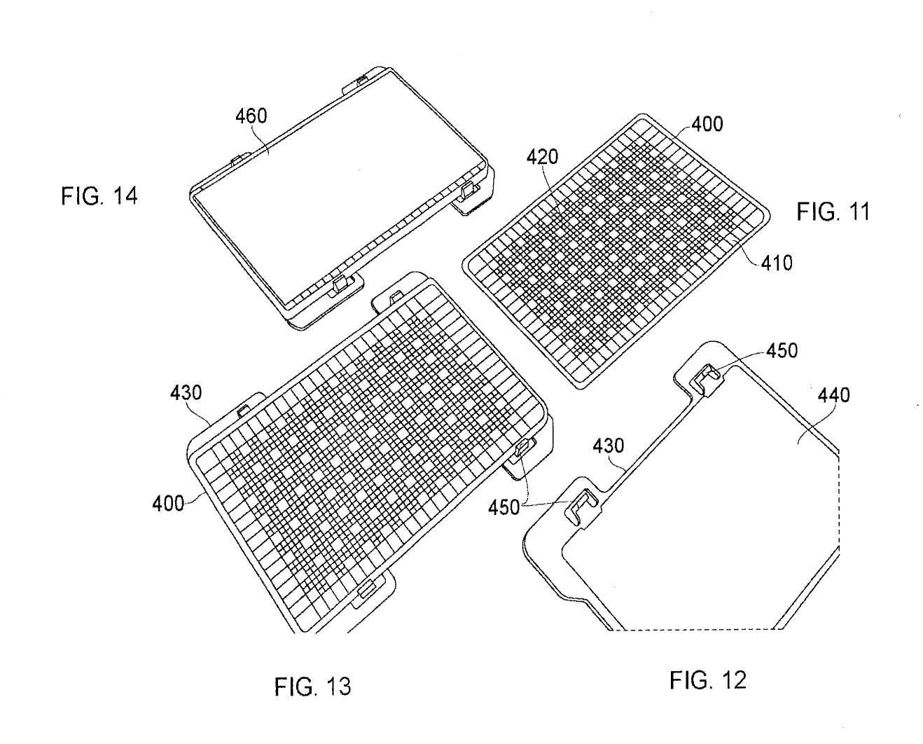

FIG. 11 provides a schematic perspective view of a microtiter plate 400 at the completion of the molding process as described above. As mentioned earlier, the plate has a rectangular shape when viewed from above (the face having the open side of the wells) dummy wells 410 may be seen around the entire periphery of the plate 400, with an array of active wells 420 provided in a region within the border formed by the dummy wells 410. In this example the active wells have two different sizes, with a smaller well having approximately one quarter the cross-sectional area of a larger well. These are arranged in the example shown in an array pattern so that a larger well is next to a similar shape divided into four smaller wells, but this is purely by way of example. Using the techniques described above, in which the mold pins 130 form each well, and in which all of the wells are formed simultaneously by simultaneous pressure by the entire cohort of mold pins, a wide variety of different patterns of wells and well sizes may be obtained.

FIG. 12 schematically illustrates a protective base plate 430 provided for the purposes of shipping the plate 400 and in particular avoiding damage to or contamination of the underside of the base of each well. A base plate can also be useful in a manual laboratory environment workflow. The application needs a high level of cleanliness (no dust) and standard laboratories are generally not cleanroom environments. The base plate can therefore be useful for providing a cover in preparation or in-between steps in a potentially dirty environment. While not actually touching the microplate the base exhibits another edge on the upper surface that inhibits the entry of dust onto the optical surfaces of the plate. The plate comprises a protective shield region 440 which (in use) sits underneath the whole of the underside of the plate 400, and resilient clips 450 which clip to the upper edge of the outer periphery of the plate 400 to hold the plate 400 onto the base plate 430. The resilient clips 450 may be gently eased away from the plate 400 to allow the release of the plate 400 from the protective base plate 430. The base plate 430 provides an example of a removable base for a microfluidic or microtiter device having a plurality of indentations, the removable base and the microfluidic or microtiter device having complementary interlocking engagements so as to provide a removable attachment between the removable base and the microfluidic or microtiter device, the removable base being disposed with respect to the microfluidic or microtiter device when attached to the microfluidic or microtiter device so that the removable base underlies the lower surface of the indentations.

FIG. 13 schematically illustrates an arrangement in which the microtiter plate 400 is fitted to the base plate 430 and is held against the base plate by the resilient clips 450, as an example of a microfluidic or microtiter device removably mounted on a removable base which, in use, underlies the lower surface of the indentations.

FIG. 14 schematically illustrates the arrangement of FIG. 13, in which a covering film 460 formed, for example, from an aluminium foil, has been applied to the upper surface (that is to say the surface with the open end of the active wells 420) in order to cover the active wells 420. Note that the covering film 460 is arranged to cover all of the active wells 420 and to extend partly over the dummy wells 410. This arrangement means that the covering film 460 does not extend completely to the outer peripheral edge of the plate 400, which in turn can help avoid damage to the covering film 460 during handling of the packaged plate of FIG. 14.

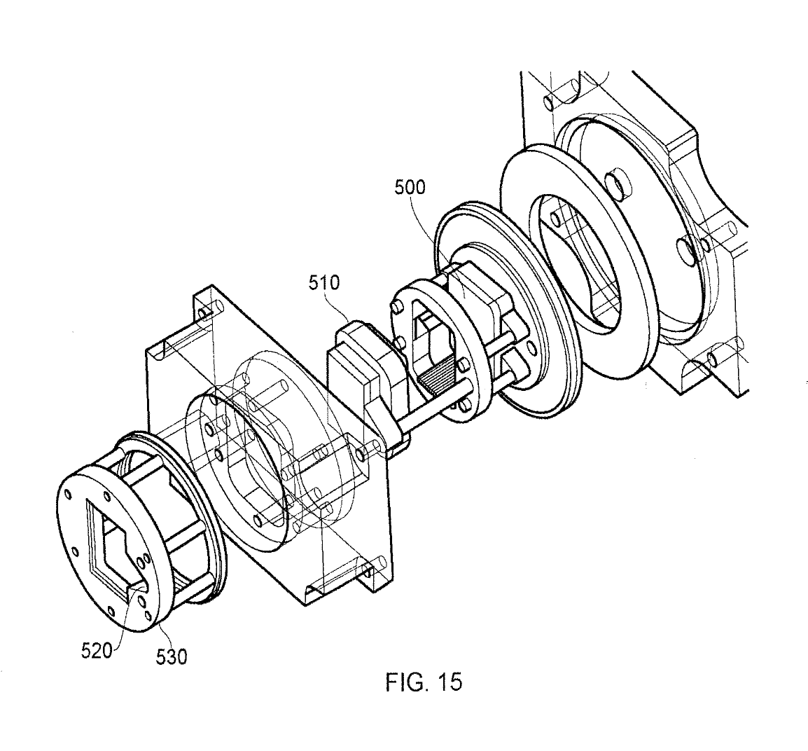

FIG. 15 schematically illustrates an exploded view of a part of a molding apparatus. This provides a practical example of parts of the apparatus shown schematically in FIGS. 3-7 and described above. In particular, FIG. 15 schematically illustrates parts which correspond to the upper mold plate 100 discussed above.

The mold pins rest on a plate 500 and are guided by a frame 510. Molten material is provided via an injection channel 520. The outer wall of the mold cavity is provided by an inner surface of a part 530.

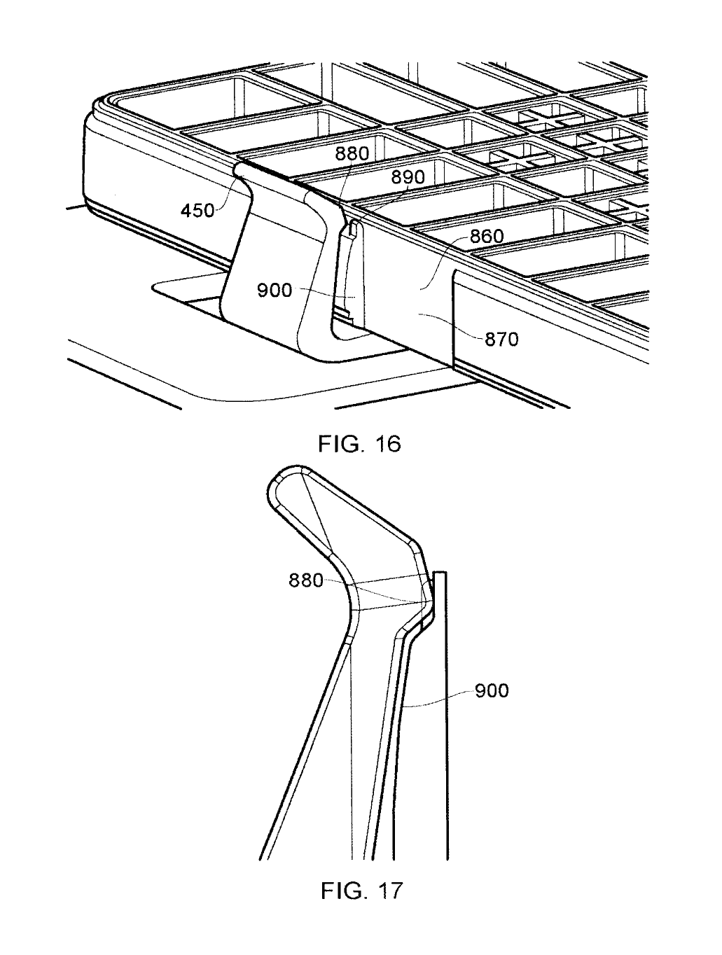

FIG. 16 is a more detailed view of a base plate attached to a microtiter plate, and FIG. 17 schematically illustrates a part of a base plate. The following description should be read in conjunction with that relating to FIGS. 11-14 discussed above.

In particular, FIG. 16 schematically illustrates the operation of one of the plural sets of interlocking formations (corresponding to the resilient clips 450 mentioned above) provided to releasably retain a microtiter plate on the base plate. As shown in FIGS. 13 and 14, the base plate engages the microtiter plate at four positions in the present embodiments, each such position being disposed generally disposed towards a respective corner of the base plate and microtiter plate.

Each of the interlocking formations comprise a clip which forms part of the base plate, and a corresponding pattern of indentations and projections 860 formed in the microtiter plate. The clip 450 is resilient so as to resist being bent in a direction away from the microtiter plate.

FIG. 16 illustrates the microtiter plate after it has been engaged with the base plate. The engagement process involves the following steps:

The microtiter plate is aligned with the base plate, above the plane of the base plate, so that each one of a set of indentations 870 is laterally aligned with a respective clip 450. The indentations 870 have a width (measured along the edge of the microtiter plate) such that the microtiter plate and the base plate may then be brought together, for example by lowering the microtiter plate onto the base plate and/or by pushing the base plate up to engage the microtiter plate. The clip 450 occupies the space corresponding to the indentation 870. The depth of the indentation is such that the clip can pass freely over the side of the microtiter plate when the clip 450 is laterally aligned with the indentation 870. A relative lateral movement is then applied so as to laterally slide the base plate and the microtiter plate with respect to one another, along a direction corresponding to the length direction of the microtiter plate. This lateral movement causes the distal (upper, as drawn) end 880 of the clip 450 to move over a projection 890 in the outer wall of the microtiter plate and enter a recess at the upper (as drawn) edge of the microtiter plate, such that there is a projection or bulge 900 between the end 880 and the plane of the base plate.

The projection or bulge 900 inhibits the microtiter plate moving upwards (as drawn) with respect to the base plate, and so serves to engage the base plate and the clip 450 with the microtiter plate.

The projection 890 inhibits lateral movement of the base plate and microtiter plate, so as to inhibit the clip 450 moving back to alignment with the indentation 870 (which would disengage the base plate from the microtiter plate. The projection 890 therefore acts as a detent mechanism.

Accordingly, once the four clips on the base plate and the corresponding formations on the microtiter plate are all engaged as shown in FIG. 16, the base plate and microtiter plate are engaged with one another.

The base plate and microtiter plate can then be disengaged, if desired, either by slightly bending the clips 450 on one side of the microtiter plate in a direction away from the microtiter plate (so allowing the clips to pass over the respective bulges 900). However, the force, although small, needed to do this could potentially bend the microtiter plate or lead to spillage of its contents. Another way of disengaging the two parts is to slide the microtiter plate and/or base plate laterally so as to realign the clip 450 and the indentation 870. This means forcing the clip 450 over the projection 890.

Examples described above have related to microtiter plates having an array of indentations. The process is not however restricted to a microtiter plate (in which a thin base is useful as discussed above) but indeed to any microfluidic part, product or component with a large ratio between the thickness of respective thicker and thinner portions. The techniques can be especially useful if there are stringent flatness requirements in the molded product (for example if microfluidic or other microstructures are being fabricated and such structures are close to the border of thick and thin regions). Example microfluidic or microtiter devices can optionally include one or more wells, and can optionally include one or more microfluidic channels. Accordingly, embodiments of the disclosure provide a microfluidic or microtiter device fabricated by a single compression injection molding operation and having one or more indentations, in which a base thickness of the one or more indentations is less than 400 μm. In embodiments, base thickness of the one or more indentations is less than 300 μm. In embodiments, the microfluidic or microtiter device is a microtiter plate having an array of indentations. In embodiments, the microfluidic or microtiter device is formed of a polymer which is transparent when set.

In a standard non-compression injection molding process the border of what is possible is a base 40 thickness of about 400 μm thinnest wall thickness. Empirical tests of the present examples achieved a base 40 thickness of 250 μm, but using the technology described here it would be possible to go as low as 200 μm, and possibly below. It should be borne in mind that a lower base 40 thickness can provide improved optical properties, which are particularly relevant and useful in situations where optical measurement or detection techniques such as confocal microscopy are used.

It will be apparent that numerous modifications and variations of the present disclosure are possible in light of the above teachings. It is therefore to be understood that within the scope of the appended claims, the technology may be practised otherwise than as specifically described herein.

Further respective aspects and features of the present disclosure are defined by the following numbered clauses:

1. A microfluidic or microtiter device fabricated by a single compression injection molding operation and having one or more indentations, in which a base thickness of the one or more indentations is less than 400 μm.
2. A microfluidic or microtiter device according to clause 1, in which the base thickness of the one or more indentations is less than 300 μm.
3. A microfluidic or microtiter device according to clause 2, in which the base thickness of the one or more indentations is less than 250 μm.
4. A microfluidic or microtiter device according to any one of the preceding clauses, in which the microfluidic or microtiter device is a microtiter plate having an array of indentations, a ratio of the internal height of the one or more indentations to the base thickness being at least 10.
5. A microfluidic or microtiter device according to clause 4, in which the array of indentations comprises two or more respective subsets of indentations, each subset of indentations having a respective indentation volume so that the indentation volumes are different for each subset of indentations.
6. A microfluidic or microtiter device according to any one of the preceding clauses, in which the microfluidic or microtiter device is formed of a polymer which is transparent when set.
7. A microfluidic or microtiter device according to any one of the preceding clauses, removably mounted on a removable base which, in use, underlies the lower surface of the indentations.
8. A microfluidic or microtiter device according to any one of the preceding clauses, in which a wall thickness of the one or more indentations is less than 2 mm.
8. A removable base for a microfluidic or microtiter device having a plurality of indentations, the removable base and the microfluidic or microtiter device having complementary interlocking engagements so as to provide a removable attachment between the removable base and the microfluidic or microtiter device, the removable base being disposed with respect to the microfluidic or microtiter device when attached to the microfluidic or microtiter device so that the removable base underlies the lower surface of the indentations.
9. A method of manufacturing a microfluidic or microtiter device, the method including:

fabricating, by a single compression injection molding operation, a microfluidic or microtiter device having one or more indentations, in which a base thickness of the one or more indentations is less than 400 μm.

10. A method according to clause 9, in which the fabricating step comprises:

forming a mold cavity;

filling the mold cavity with molten material;

closing the mold cavity; and

driving one or more molding formations complementary to the one or more indentations into the mold cavity.

11. A method according to clause 10, in which the one of more molding formations are mold pins, one pin for each indentation.
12. A method according to clause 11, in which the mold pins are at least 70 mm long.
13. A method according to clause 11 or clause 12, in which, for at least a portion of their length which forms a corresponding indentation, the mold pins are tapered so as to be narrower at a distal end.
14. A method according to any one of clauses 10 to 13, in which the driving step comprises driving the molding formations into the mold cavity using a hydraulic press.
15. A method according to any one of clauses 10 to 14, in which the mold cavity, before the step of driving the molding formations into the cavity, has a lower thickness than a required thickness of the microfluidic or microtiter device.
16. A method according to any one of clauses 10 to 15, in which the step of driving the molding formations into the cavity comprises driving the molding formations from one side of the cavity towards an opposite side of the cavity so that a distal end of each molding formation reaches a position within 400 μm of a surface of the opposite side of the cavity.
17. A method according to clause 16, in which a distal end of each molding formation reaches a position within 300 μm of a surface of the opposite side of the cavity.
18. A method according to clause 17, in which a distal end of each molding formation reaches a position within 250 μm of a surface of the opposite side of the cavity.
19. A method according to any one of clauses 10 to 18, including the step of cooling the mold cavity, the cooling step including cooling different parts of the mold cavity to different temperatures.
20. A method according to clause 19, including selecting the different temperatures so that the molded microfluidic or microtiter device is bowed when released from the mold cavity, the method including applying a further process to the molded microfluidic or microtiter device so as to introduce a substantially complementary bowing, thereby producing a substantially flat microfluidic or microtiter device.
21. A method according to clause 20, in which the step of applying a further process comprises covering at least some of the indentations with a covering film.
22. A method according to any one of clauses 10 to 21, including the step of directing a cooling gas around the periphery of at least some of the moulding formations.
23. A method according to any one of clauses 10 to 22, in which the microfluidic or microtiter device is a microtiter plate having an array of indentations.
24. A method according to clause 23, in which the material is a polymer which is transparent when set.

25. A method according to clause 24, in which the polymer is selected from the list consisting of:
Cyclo Olephine Polymer grades with glass transition temperature (Tg) between 100 and 160° C.;
Cyclo Olephine Copolymer grades with glass transition temperature (Tg) between 100 and 160° C.;
Polypropylene;
Polystyrene;
Polycarbonate;
Polymethyl methacrylate;
PVC (Polyvinyl chloride);
PPE (Polyphenyl ether);
SAN (Styrene-acrylonitrile);
PET (Polyethylene terephthalate);
PE (Polyethylene); and
Copolymers and blends of any permutation of these polymers.
   26. A method according to any one of clauses 9 to 25, in which the step of forming the mold cavity comprises driving a plurality of mold parts together.

1. A microfluidic or microtiter device fabricated by a single compression injection molding operation and having one or more indentations, in which a base thickness of the one or more indentations is less than 400 μm.

2. A microfluidic or microtiter device according to claim 1, in which the base thickness of the one or more indentations is less than 300 μm.

3. A microfluidic or microtiter device according to claim 2, in which the base thickness of the one or more indentations is less than 250 μm.

4. A microfluidic or microtiter device according to claim 1, in which the microfluidic or microtiter device is a microtiter plate having an array of indentations, a ratio of the internal height of the one or more indentations to the base thickness being at least 10.

5. A microfluidic or microtiter device according to claim 4, in which the array of indentations comprises two or more respective subsets of indentations, each subset of indentations having a respective indentation volume so that the indentation volumes are different for each subset of indentations.

6. A microfluidic or microtiter device according to claim 1, in which the microfluidic or microtiter device is formed of a polymer which is transparent when set.

7. A microfluidic or microtiter device according to claim 1, removably mounted on a removable base which, in use, underlies the lower surface of the indentations.

8. A method of manufacturing a microfluidic or microtiter device, the method comprising:
fabricating, by a single compression injection molding operation, a microfluidic or microtiter device having one or more indentations, in which a base thickness of the one or more indentations is less than 400 μm.

9. A method according to claim 8, in which the fabricating step comprises:
forming a mold cavity;
filling the mold cavity with molten material;
closing the mold cavity; and
driving one or more molding formations complementary to the one or more indentations into the mold cavity.

10. A method according to claim 9, in which the one of more molding formations are mold pins, one pin for each indentation.

11. A method according to claim 10, in which the step of forming the mold cavity comprises driving a plurality of mold parts together.

12. A method according to claim 10, in which, for at least a portion of their length which forms a corresponding indentation, the mold pins are tapered so as to be narrower at a distal end.

13. A method according to claim 9, in which the step of driving the molding formations into the cavity comprises driving the molding formations from one side of the cavity towards an opposite side of the cavity so that a distal end of each molding formation reaches a position within 400 μm of a surface of the opposite side of the cavity.

14. A method according to claim 13, in which a distal end of each molding formation reaches a position within 300 μm of a surface of the opposite side of the cavity.

15. A method according to claim 14, in which a distal end of each molding formation reaches a position within 250 μm of a surface of the opposite side of the cavity.

16. A method according to claim 9, comprising the step of cooling the mold cavity, the cooling step comprising cooling different parts of the mold cavity to different temperatures.

17. A method according to claim 9, comprising the step of directing a cooling gas around the periphery of at least some of the moulding formations.

18. A method according to claim 9, in which the microfluidic or microtiter device is a microtiter plate having an array of indentations.

19. A method according to claim 18, in which the material is a polymer which is transparent when set.

20. A method according to claim 19, in which the polymer is selected from the list consisting of:
Cyclo Olephine Polymer grades with glass transition temperature (Tg) between 100 and 160° C.;
Cyclo Olephine Copolymer grades with glass transition temperature (Tg) between 100 and 160° C.;
Polypropylene;
Polystyrene;
Polycarbonate;
Polymethyl methacrylate;
PVC (Polyvinyl chloride);
PPE (Polyphenyl ether);
SAN (Styrene-acrylonitrile);
PET (Polyethylene terephthalate);
PE (Polyethylene); and
Copolymers and blends of any permutation of these polymers.
